(19) United States
(12) Patent Application Publication
(10) Pub. No.: US 2005/0191971 A1
(43) Pub. Date: Sep. 1, 2005

(54) Assisted listening device

(76) Inventors: Michael K. Boone, Los Angeles, CA (US); Bradley C. Davis, Corona del Mar, CA (US); Richard Nazarian, Excelsior, MN (US); John Rodgers Davis, Santa Fe, NM (US); William S. Holbrook III, Pasadena, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/867,347

(22) Filed: Jun. 14, 2004

Related U.S. Application Data
(60) Provisional application No. 60/547,830, filed on Feb. 26, 2004.

(51) Int. Cl. H04B 1/38

(52) U.S. Cl. 455/90.3; 455/575.1

(57) ABSTRACT

According to one embodiment of the invention, a method of operation involves concurrently receiving spread-spectrum wireless signals from a plurality of sources by a listening device for a hearing-impaired user. These spread-spectrum wireless signals comprise audio in a digital format. The audio is filtered so as to retain audio within a specified audible frequency range set by the hearing-impaired user. The filtered audio is converted into an analog format, and thereafter, is subsequently output for perception by the user. This provides a cost-effective solution for the hearing-impaired in order to avoid unwanted ambient noise normally amplifier by conventional hearing aids.

### CROSS-REFERENCE TO RELATED APPLICATIONS

This application claims the benefit of U.S. Provisional Application No. 60/547,830 filed Feb. 26, 2004.

### BACKGROUND

1. Field

Embodiments of the invention relate to an assisted listening device for hearing-impaired persons as well as the system and method of operation thereof.

2. General Background

Hearing loss is the third leading chronic disability following arthritis and hypertension. It is estimated that over twenty million Americans have significant hearing loss; many of these persons have forms of hearing loss that affect their ability to distinctly hear sounds during a conversation. As the American population lives longer, there will be more and more people with significant hearing loss.

Various types of hearing loss, such as nerve-type, can be partially remedied through the use of hearing aids. Conventional hearing aids electronically amplify sound waves received at the ear. Although hearing aids may be tailored to amplify only a particular frequency range to compensate for the specific hearing loss of a particular individual, they also universally amplify all sound, including unwanted ambient noise. As a result, hearing aids provide little assistance during one-to-one or group conversations in a noisy public environment, such as a restaurant or theater for example, because such aids do not differentiate a desired sound (an acoustic signal) from unwanted ambient noise.

Moreover, conventional hearing aids typically undergo extensive miniaturization so as to discretely conceal their presence. This reduction in size increases overall design and manufacturing costs, which is passed down to the consumers. As a result, a high percentage of hearing-impaired persons cannot afford hearing aids, and thus, may experience a reduced quality of life.

It would be advantageous to develop a convenient, unobtrusive, discrete and economical listening system that enables normal conversation between a hearing-impaired person and others, even in a noisy ambient environment.

### BRIEF DESCRIPTION OF THE DRAWINGS

Embodiments of the invention are illustrated by way of example and not by way of limitation in the accompanying drawings, in which like references indicate similar elements and in which:

FIG. 1 is a first exemplary embodiment of a hearing-impaired communication system deployed as a spread spectrum wireless network;

FIG. 2 is a first embodiment of an assisted listening device (L-Device) operating as a receiver;

FIG. 3 is a perspective side view of the L-Device of FIG. 2;

FIG. 4 is a second exemplary embodiment of the L-Device of FIG. 1;

FIG. 5 is an exemplary embodiment of internal circuitry within an L-Device;

FIG. 6 is a detailed embodiment of the internal circuitry within the L-Device of FIG. 5;

FIG. 7 is a third exemplary embodiment of the L-Device of FIG. 1;

FIG. 8 is a first exemplary embodiment of a talking device (T-Device) of the hearing-impaired communication system of FIG. 1;

FIG. 9 is an exemplary embodiment of internal circuitry of a T-Device accompanied by an L-Device;

FIG. 10 is a second exemplary embodiment of a hearing-impaired communication system;

FIG. 11 is another embodiment of a stereophonic headset for the L-Device as shown in FIG. 10;

FIG. 12 is an embodiment of internal circuitry within the T-Device of FIG. 10;

FIG. 13 is an exemplary embodiment of a group charger for one or more L-Devices and/or T-Devices;

FIG. 14 is a third exemplary embodiment of a hearing-impaired communication system;

FIG. 15 is an exemplary embodiment of a T-Device with peripheral connectivity;

FIG. 16 is a fourth exemplary embodiment of a hearing-impaired communication system deployed as an expandable fixed frequency or spread spectrum network;

FIG. 17A is an exemplary embodiment of internal circuitry within the T-Device of the hearing-impaired communication system of FIGS. 16;

FIG. 17B is an exemplary embodiment of internal circuitry within the L-Device 1500 of the hearing-impaired communication system of FIGS. 16;

FIG. 18 is a fifth exemplary embodiment of a hearing-impaired communication system deployed as a designated call center;

FIG. 19 is a sixth exemplary embodiment of a hearing impaired communication system;

FIG. 20 is an exemplary embodiment of a built-in interconnect recoil mechanism situated within a L-Device or T-Device;

FIG. 21 is an exemplary embodiment of an infrared based hearing-impaired communication system;

FIG. 22 is an exemplary embodiment of a hearing-impaired communication system deploying an all-in-one earpiece; and

FIG. 23 is an exemplary embodiment of a hearing-impaired communication system utilizing laser pointer activation of an IR detector of a T-Device.

### DETAILED DESCRIPTION

Various embodiments of the invention relate to a hearing-impaired communication system deploying an assisted listening device and one or more talking devices. The assisted listening device enables hearing-impaired persons to better comprehend speech conversations, especially in an environment having a high level of ambient noise such as a restaurant, theater, or any public meeting place. Examples of ambient noise sources include, but are not limited to the following: conversations by others in the background, equipment noise (e.g., heating, air conditioning, office equipment), road traffic or the like.

In the following description, certain terminology is used to describe features of the invention. For instance, the term “device” is representative of hardware and/or software configured to perform one or more functions. An example of “hardware” includes, but is not limited or restricted to a collection of electronic circuitry such as tunable receivers, gain amplifiers, speakers, filters, signal converters or the like. Likewise, an example of “software” includes a series of executable instructions in the form of an application, an applet, or even a routine. The software may be stored in any type of machine readable medium such as a programmable electronic circuit, a semiconductor memory device such as volatile memory (e.g., random access memory, etc.) and/or non-volatile memory (e.g., any type of read-only memory “ROM”, flash memory), a floppy diskette, an optical disk (e.g., compact disk or digital video disc “DVD”), a hard drive disk, tape, or the like.

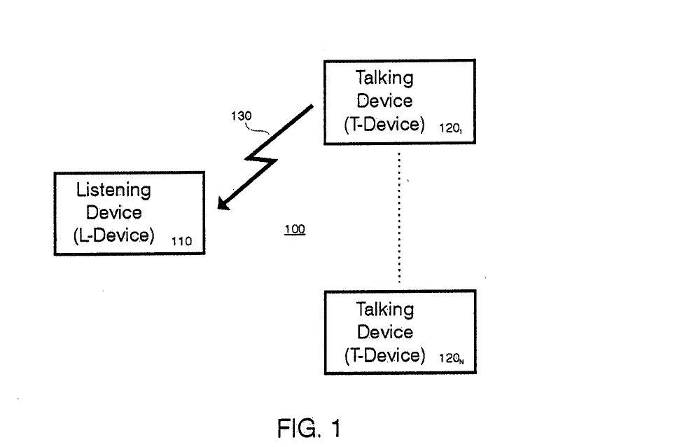

Referring now to FIG. 1, a first exemplary embodiment of a hearing-impaired communication system 100 deployed as a spread spectrum wireless network is shown. Communication system 100 comprises an assisted listening device 110 (referred to as “L-Device”) and “N” talking devices 120₁-120_{N}, where N≧1 (referred to as “T-Device”).

L-Device 110 may be configured to listen to all T-Devices 120₁-120_{N} simultaneously with no cutouts. This implementation is a fully multiplexed scheme. It is contemplated, however, that L-Device 110 may be configured to listen to only one T-Device 120₁, . . . , or 120_{N} at a time. Each T-Device 120₁-120_{N} is registered with L-Device 110 in its communication cell area. Such registration may be accomplished by T-Device providing a login code to L-Device 110.

In particular, during power-up of a T-Device (e.g., T-Device 120₁, the registration process begins by generating a login code 130, which may be a pseudo-random number or a random number. The login code 130 is transmitted in a broadcast fashion from T-Device 120₁ to any L-Devices in its general proximity. L-Device 110 receives the login code 130 and stores the login code 130 within volatile memory and/or non-volatile memory implemented within L-Device 110. Thereafter, any audio communications from T-Device 120₁ to L-Device 110 are recognized and processed.

Of course, although not shown, it is contemplated that L-Device 110 may initiate registration by broadcasting a registration message for receipt by all T-Devices 120₁-120_{N} within its broadcast area. This may prompt T-Devices 120₁-120_{N} to generate login codes and transmit these login codes to L-Device 110 via a registration response message.

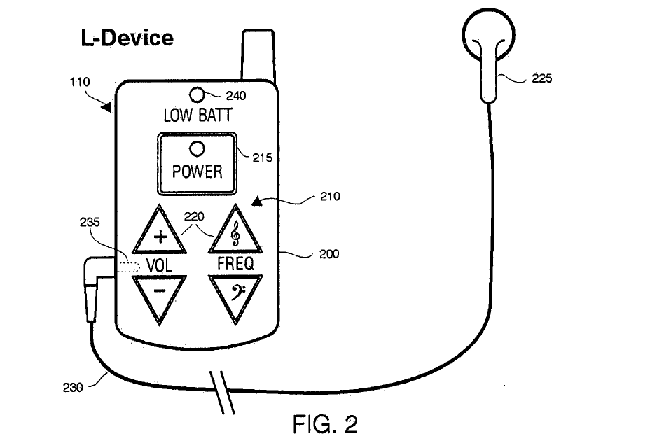

Referring now to FIG. 2, a first exemplary embodiment of L-Device 110 operating as a receiver is shown. Herein, according to one embodiment, L-Device 110 is assembled to resemble a cellular telephone, but with oversized, highly tactile input/output (I/O) controls to accommodate for lack of dexterity or vision normally found in the hearing-impaired demographic group. L-Device 110 comprises a body case 200 made of a semi-rigid material (e.g., hardened plastic, metal, etc.) and provides water and/or shock resistance in order to protect the inner circuitry from contaminants and adverse weather conditions. The body case 200 comprises a plurality of openings to allow a user visual or physical access to the I/O controls.

For instance, as shown in FIG. 2, I/O controls 210 may protrude through prescribed openings in body case 200 to enable the user to adjust the functionality of L-Device 110. Examples of I/O controls 210 may include, but are not limited or restricted to a power button 215 and volume control buttons 220 to adjust the volume and audio frequency ranges. This enables the listener to concentrate the incoming audio signal on user-specific audible frequency ranges.

In addition, L-Device 110 further comprises an earpiece 225 that is connected to body case 200 via an interconnect 230 and input port 235. Input port 235 may be an RJ-11 jack or other jack adapted for earpiece 225. Interconnect 230 may be a wired or wireless (infrared or radio frequency) connection.

L-Device 110 further comprises an optional low battery indicator 240 visible on a top surface of body case 200. When L-Device 110 is in a low power state, battery indicator 240 is illuminated in order to signal the listener that the current power supply should be replaced or recharged. Of course, in lieu of battery indicator 240, it is contemplated that a warning of a low battery condition may be accomplished through audio signals propagating through to earpiece 225 or an audible sound over a speaker (not shown) on L-Device 110.

Although not shown, a liquid crystal display may be implemented as an optional I/O control 210 in order to identify devices in communication with L-Device 110.

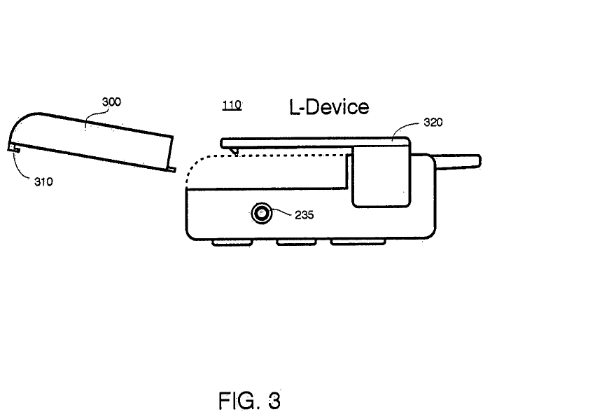

Referring now to FIG. 3, a perspective side view of L-Device 110 of FIG. 2 is shown. L-Device 110 further comprises a removable power supply 300 that is disposable or rechargeable and a coupling mechanism 310 to maintain power supply 300 in a connected state. L-Device 110 is further adapted with a clip 320 that allows L-Device 110 to be coupled to a belt or waistband for placement under clothing for those users that want a discreet listening device. The oversized tactile I/O controls 210 would allow for adjustment to be made through clothing. It is contemplated that in lieu of clip 320, a coupling mechanism may be deployed on a top surface of L-Device 110 in order to allow a cord or necklace to be inserted through the coupling mechanism so that the L-Device 110 may be worn around the user's neck.

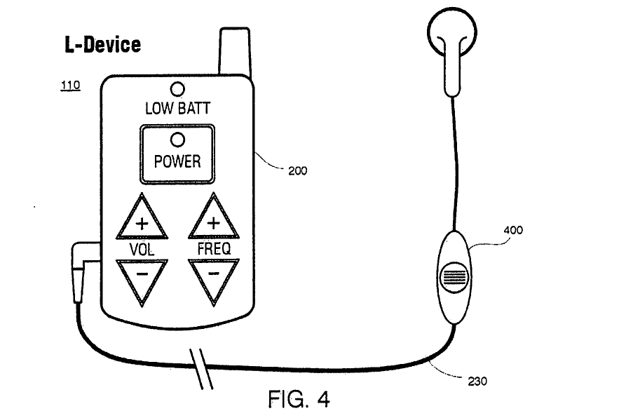

Referring now to FIG. 4, a second exemplary embodiment of L-Device 110 of FIG. 1 is shown. Herein, for this embodiment, L-Device 110 comprises a microphone 400 positioned to allow a listener to better hear persons (without a T-Device) talking in close proximity. For instance, microphone 400 may be positioned along interconnect 230 and slightly angled from a forward facing direction in order to better hear audible speech from a person in close proximity to the listener.

Alternatively, although not shown, microphone 400 may be positioned on an edge surface of casing 200 facing upward. This implementation enables microphone 400 to detect audio from persons situated above and directly in front of the listener. For instance, microphone 400 is positioned to better hear a waitress, a cashier or another person directly talking to the listener, even while the listener is engaged in communications.

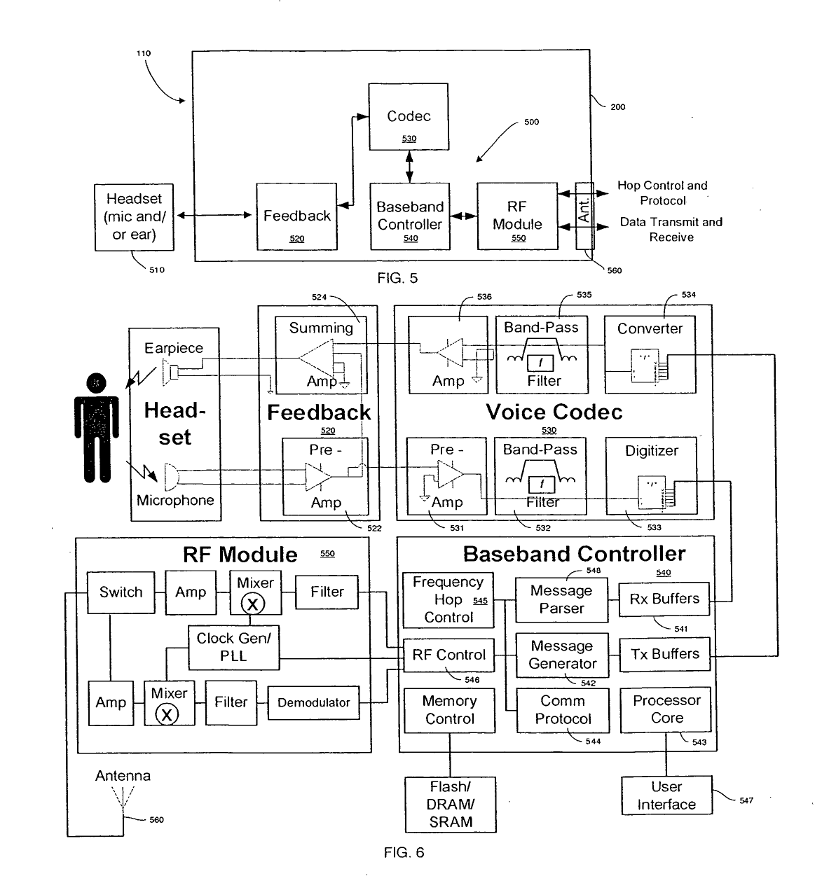

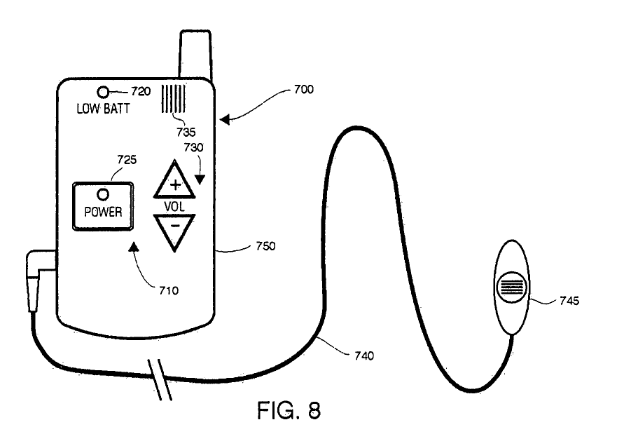

Referring now to FIGS. 5 and 6, an exemplary embodiment of internal circuitry 500 within L-Device 110 of FIGS. 2 and 4 is shown. It is contemplated that the general architecture of L-Device 110 is equivalent to the architecture of any of T-Devices 120₁, . . . , or 120_{N}, except for implementation of an earpiece or microphone connected to body case 200 via an interconnect and input port. It is contemplated, however, that T-Devices 120₁, . . . , or 120_{N} may be implemented with distinct architectures as shown in FIG. 8.

In general, internal circuitry 500 comprises a feedback circuit 520, a voice coder/decoder (codec) 530, a baseband controller 540, a radio frequency (RF) module 550 and an antenna 560. Antenna 560 is designed to receive and transmit signals according to a predetermined frequency range. For instance, the signals can be within 2.1 to 2.5 Gigahertz (GHz) range. In essence, the combination of L-Devices and registered T-Devices that collectively form a BLUETOOTH® party line to exchange voice data over common channels of a wireless BLUETOOTH® Spread-Spectrum network.

A headset 510 comprises an earpiece and/or microphone. When collectively implemented, both of these components are coupled to feedback circuit 520, which provides local feedback from a pre-amplifier 522 to a summing amplifier 524. This provides sufficient signal amplification and enables the user to listen to himself or herself talk at an appropriate gain level.

Voice Codec 530 provides a pre-amplifier 531, a band-pass filter 532 and a digitizer 533 in the transmit (TX) direction. The combination of components is responsible for digitizing an incoming analog signal received from microphone 400. The digitized data is routed to storage memory (e.g., RX buffer 541) of baseband controller 540. In the receive (RX) direction, however, a digital-to-analog converter (DAC) 534, band-pass filter 535 and amplifier 536 are used to produce an analog signal representative of digital data processed by baseband controller 540.

Baseband controller 540 operates in a conventional manner. In general, a message generator 542 is executed by a processor core 543 (e.g., digital signal processor, general microprocessor, a micro-controller, etc.) to generate a message. The message is based on at least a portion of digitized audio data contained in RX buffer 541 and a selected communication protocol 544. This message is transmitted based on a selected frequency set forth by frequency hop control 545. An RF control circuit 546 provides control information for the clock generator/phased-lock loop (PPL) to cause RF module 550 to transmit information at the selected frequency assigned by frequency hop control 545.

As shown, a user interface 547 is in communication with processor core 543, which is responsible for generating the wireless message as well as parsing data (by message parser 548) from a wireless message for transfer to voice codec 530 for conversion. User interface 547 includes I/O controls while memory 549 contains programs, login codes and the like.

As further shown in FIGS. 5 and 6, RF module 550 is a conventional unit that provides RF data transmissions and RF data reception inclusive of filtering, amplification, and demodulation.

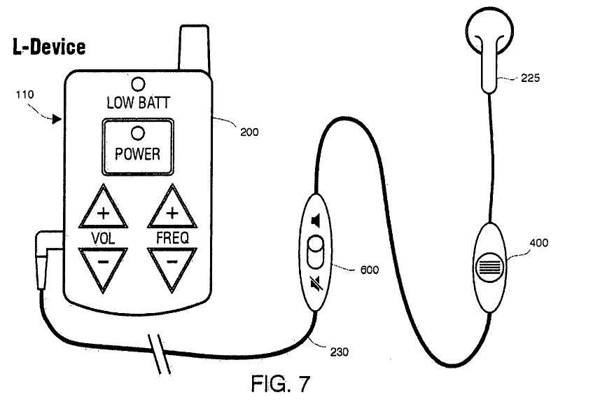

Referring now to FIG. 7, a third embodiment of L-Device 110 of FIG. 1 is shown. Herein, for this embodiment, L-Device 110 is implemented with a cutout switch 600 that will discontinue the routing of audio signals from the L-Device 110 into earpiece 225. According to one embodiment of the invention, cutout switch 600 may be situated along interconnect 230. Alternatively, it is contemplated that cutout switch 600 may be situated on a top surface of body case 200, or on earpiece 225 itself.

When cutout switch 600 is moved from a first position (as shown) to a second position, the audio signals received from L-Device 110 are not routed to earpiece 225. Instead, audio signals associated with ambient noise recovered from microphone 400 are routed to earpiece 225. As shown, microphone 400 is situated along interconnect 230.

Referring now to FIG. 8, a first exemplary embodiment of talking device (T-Device) of hearing-impaired communication system 100 is shown. For this embodiment, T-Device 700, equivalent to T-Device 120₁ of FIG. 1 for example, is deployed having a different construction from L-Device 110 of FIG. 2. More specifically, T-Device 700 comprises tactile controls 710 which may include, but is not limited or restricted to, a low battery indicator 720, power 725 and a volume reset control 730 to adjust volume (gain) for an audio transmission. T-Device 700 further comprises an optional audio speaker 735. Audio speaker 735 may be used to indicate to the user that the battery power level is low in lieu of or in addition to low battery indicator 720.

T-Device 700 further comprises an interconnect 740 attached to a microphone 745. Interconnect 740 may be a wired or wireless connection between microphone 745 and circuitry internally situated within casing 750 of T-Device 700.

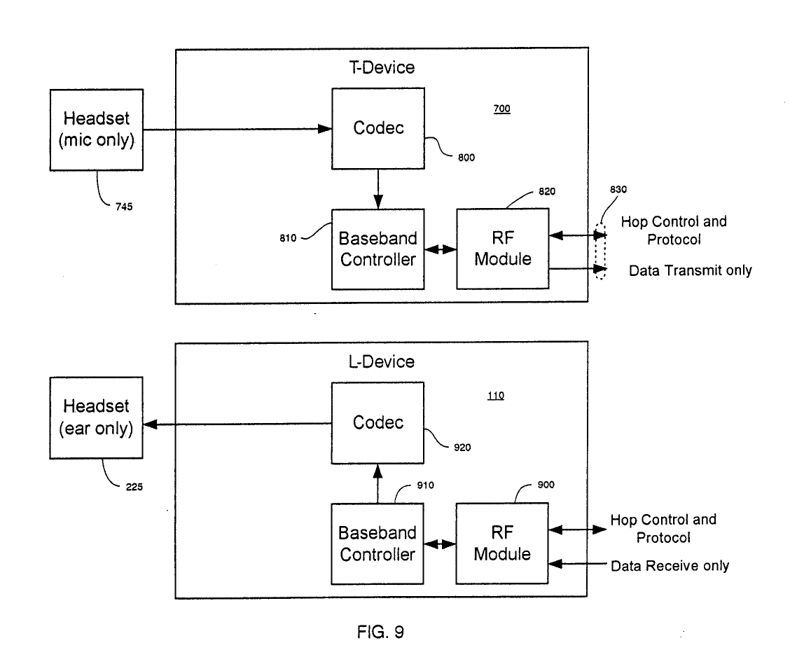

Referring now to FIG. 9, an exemplary embodiment of internal circuitry within T-Device 700 of FIG. 8 and an accompanying L-Device, such as L-Device 110 of FIG. 2 for example, is shown. T-Device 700 comprises microphone 745 that communicates with a codec 800 to convert the analog signals into digital data. The digital data is routed to a baseband controller 810 that produces RF messages. These RF messages are routed to an RF module 820 which, using frequency hop control and protocol, creates wireless packets 830 for transmission.

L-Device 110 receives the wireless packets from RF module 900 and performs amplification, filtering and demodulation operations on information associated with the wireless packets. The resultant information is provided to a baseband controller 910, which parses the information to recover the digital data. The digital data is routed to a codec 920, which converts the digital data into analog signals that are routed to one or more earpieces 225.

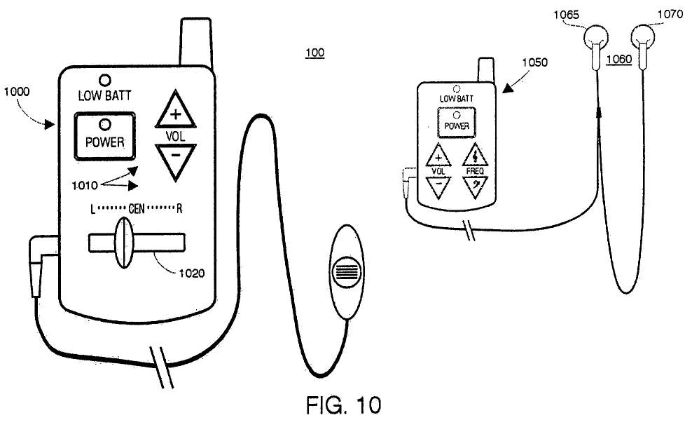

Referring now to FIG. 10, a second exemplary embodiment of hearing-impaired communication system 100 is shown. For this embodiment, a talking device (T-Device) 1000 is substantially similar to T-Device 700 deployed within hearing-impaired communication system 100 of FIG. 8 is shown. However, as one of tactile controls 1010, T-Device 1000 further comprises a bias control 1020 to appropriately bias audio signals transmitted to a L-Device 1050. L-Device 1050 is generally identical to L-Device 110 of FIG. 2 except for a stereophonic headset 1060 adapted to L-Device 1050.

According to this embodiment, bias control 1020 is a user adjusted, three-position switch (not shown) that appropriately biases audio signals transmitted to L-Device 1050. Bias control 1020 specifies the location of the listener (LEFT, CENTER, RIGHT) with respect to the talker. The CENTER position may be chosen as the default position, and the switch is returned to the center position after a disruption of power.

More specifically, internal circuitry within T-Device 1000 produces a packet of audio data that includes a field that specifies the general position (00=LEFT, 01=FACING, 10=RIGHT) of the talker to the listener based on the setting of bias control 1020. Thus, if the listener is facing the talker, but slightly to the right of the talker and bias control 1020 is set accordingly, the audio signals at the L-Device 1050 are biased so that audio signals routed to a right earpiece 1065 of headset 1060 is amplified more than audio signals routed to a left earpiece 1070 of L-Device 1050.

Of course, it is contemplated that other transmission techniques may be used to identify the position of the talker to the listener. For instance, bias control 1020 may be a slidable adjustment bar as shown. The relative position of the bar would indicate in what direction the listener is to the talker. Thus, when T-Device 1000 transmits audio data packets to L-Device 1050, these packets include an 8-bit field to specify the general position (in code to denote left/right/center, degrees, etc.) from the talker. A conversion (e.g., 180 degrees minus degrees provided) may be needed to compute the location of the talker to the listener in order to bias right earpiece 1065 and/or left earpiece 1070 of headset 1060.

Moreover, in accordance with another embodiment of the invention, bias contol 1020 may be accomplished by an array of LEDs controlled by momentary switches instead of a positionable switch as described above.

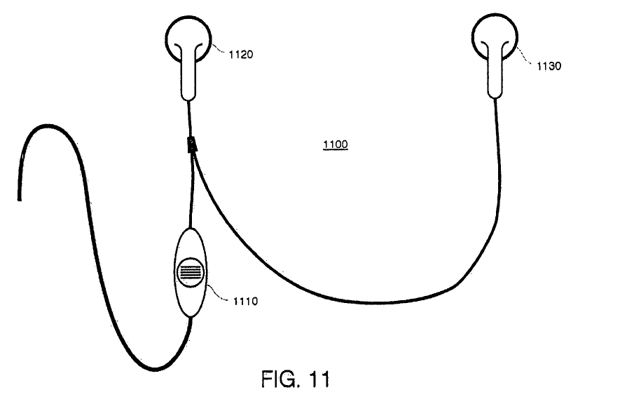

As shown in FIG. 11, it is contemplated that L-Device 1050 may deploy a stereophonic headset 1100 that comprises a microphone 1110 and a pair of earpieces 1120 and 1130. This embodiment differs from the embodiment of FIG. 10 in which headset excludes microphone 1110.

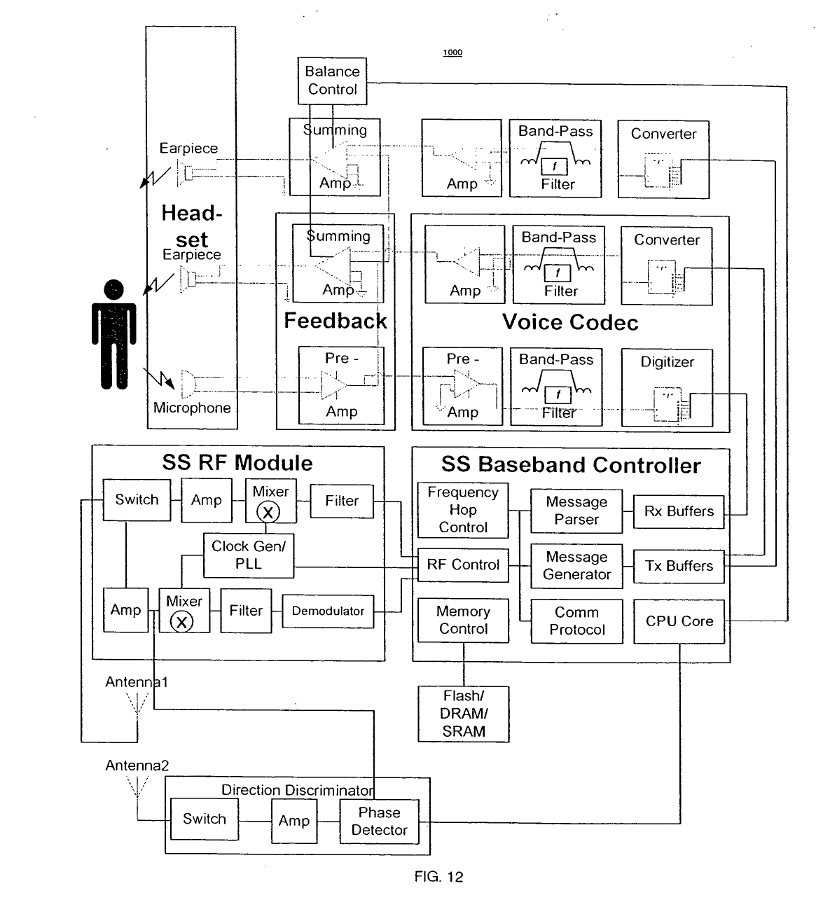

Referring to FIG. 12, an exemplary embodiment of internal circuitry within T-Device 1000 of FIG. 10 is shown. For directional analysis, a dual-ended antenna accessory may be used to orient the user through analysis of signal time or delta phase to triangulate T-Device locations and bias the audio signal appropriately to the listener's earpieces. Alternatively a dual-ended antenna can be built in L-Device 1050 with the ability to analyze signal time or delta phase, triangulate the T-Device's location and bias audio as received by the listener's earpieces.

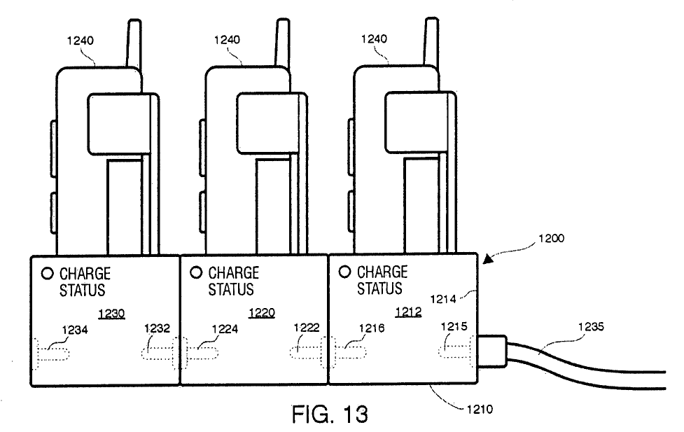

Referring now to FIG. 13, an exemplary embodiment of a group charger 1200 for one or more L-Devices and/or T-Devices is shown. For this embodiment, each L-Device would feature an external recharging connector that enables the battery to be recharged. For instance, according to one embodiment, the external recharging connector would protrude from a bottom or side panel of the casing of the L-Device or T-Device. According to another embodiment, the external recharging connector would be implemented as a port (or female connector).

As shown, group charger 1200 comprises a plurality of charge stations 1210, 1220 and 1230, which are electrically coupled together. Upon inserting the plug of a power cord 1235 into a power source (e.g., Alternating Current “A/C” wall socket, cigarette lighter, etc.), power is supplied to a primary charge station 1210. This enables a battery of any L-Device or T-Device (hereinafter referred to as an “L/T-Device”) 1240 placed in primary charge station 1210 to be charged.

As shown, primary charge station 1210 comprises a cradle 1212 featuring an inner sidewall 1214. A connector 1215 is positioned along inner sidewall 1214. When L/T-Device 1240 is placed into cradle 1212, connector 1215 comes into contact with the external recharging connector of L/T-Device 1240. Primary charge station 1210 further comprises an indicator 1218 to indicate a charge level of the L/T-Device and an auxiliary connector 1216 positioned along a sidewall of cradle 1212 for electrically coupling a neighboring charge station 1220 to receive power from power cord 1225.

As shown, each of the secondary charge stations 1220 and 1230 differ from primary charge station 1210 because these stations 1210 and 1230 include two auxiliary connectors 1222 & 1224 and 1232 & 1234 at opposite sidewalls. Primary charge station 1210, in contrast, features a single auxiliary connector 1216 since with power cord 1235 for coupling to a power source.

It is contemplated that each of these charge stations 1210, 1220 and 1230 features an automatic shut-off to sense when a battery of an L/T Device is fully charged so that no overcharging damage is done to these batteries. Of course, in lieu of the serial recharging scheme as shown in FIG. 12, it is contemplated that each of these charge stations 1210, 1220 and 1230 may be adapted with separate power cords.

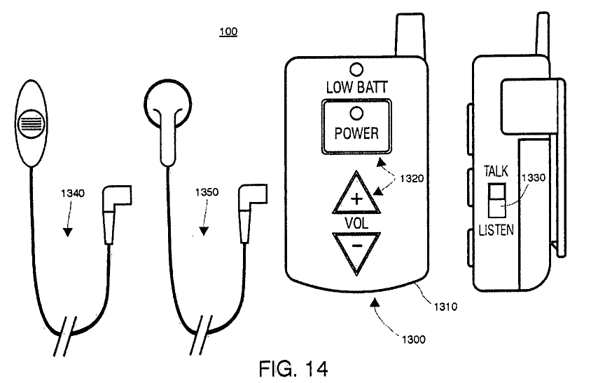

Referring now to FIG. 14, a third exemplary embodiment of hearing-impaired communication system 100 is shown. For this embodiment, a talking device (T-Device) 1300 is identical to a listening device (L-Device) and is shown as a listening/talking (L/T) device 1300. Each L/T device 1300 comprises a casing 1310 and a plurality of I/O controls 1320 as described in FIG. 2 for example. One notable distinction, however, is that L/T device 1300 comprises a manual switch 1330 that can convert the L/T device 1300 into a L-Device or a T-Device. Separate types of headsets 1340 and 1350 adapted to the L/T device 1300 to operate as a T-Device or L-Device, respectively.

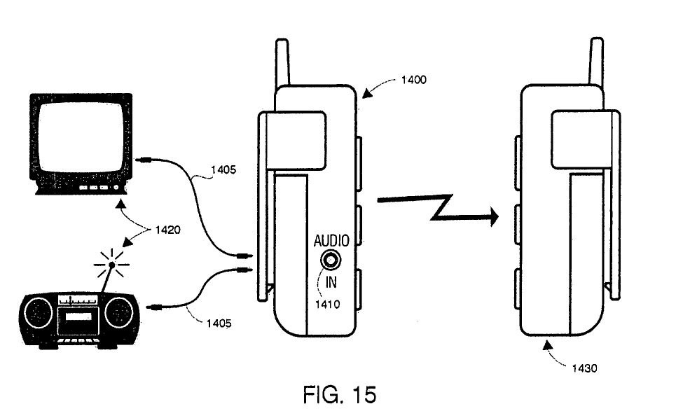

Referring now to FIG. 15, an exemplary embodiment of a T-Device with peripheral connectivity is shown. T-Device 1400 comprises at least one audio port 1410 adapted to receive audio signals from a corresponding peripheral audio/video (A/V) unit 1420. According to one embodiment of the invention, the audio port 1410 provides a secondary communication interface, separate from an input port for coupling with an interconnect having a microphone and/or earpiece, that receives an incoming audio signal and prepares for transmission to one or more L-Devices 1430. Alternatively, however, audio port 1410 is the same input port for coupling to the interconnect having the microphone.

As shown, audio signals are analog signals provided to T-Device 1400 from a peripheral A/V unit 1420 (e.g., television, radio, compact disk player, MP3 player, etc.) via an audio interconnect 1405. The audio interconnect 1405 may be a cable adapted for coupling to audio port 1410. Alternatively, audio interconnect may be air to receive an IR or RF signal from peripheral A/V unit 1420. T-Device 1400 broadcasts an audio signal to all L-Devices in the broadcast range, which cause audio playback directly to an earpiece (not shown) of L-Device 1430.

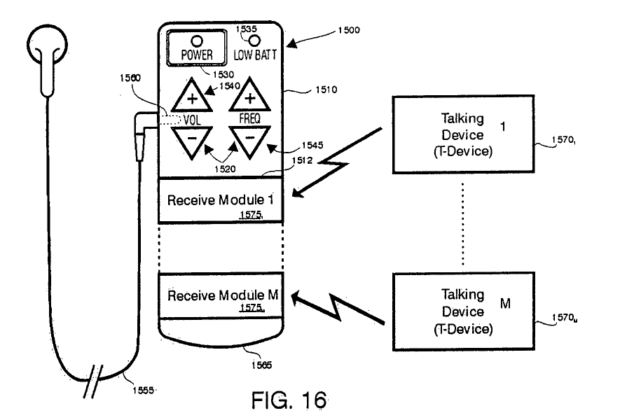

Referring now to FIG. 16, a fourth exemplary embodiment of hearing-impaired communication system 100 deployed as an expandable spread spectrum or fixed frequency network is shown. For illustration purposes, however, a fixed frequency network implementation is described below. However, it is evident that the same configuration may be used as a spread-spectrum network in order to minimize the need to develop chips to handle multiple transmitters. Instead, one type of chip can be used in each added module, provided the received audio signals are mixed together.

Herein, L-Device 1500 comprises a body case 1510 made of a semi-rigid material (e.g., hardened plastic, metal, etc.) and provides water and/or shock resistance in order to protect the inner circuitry from contaminants and adverse weather conditions. Body case 1510 comprises openings for a corresponding number of I/O controls 1520 to adjust the functionality of L-Device 1500. Examples of I/O controls 1520 may include, but are not limited or restricted to a power control 1530, a low-battery indictor 1535, a pair of volume controls 1540 to adjust the volume, a pair of audio frequency controls 1545 to enable the listener to concentrate an incoming audio signal on user-specific audible frequency ranges.

In addition, L-Device 1500 further comprises a headset 1550 having an interconnect 1555 that is configured for insertion into an input port 1560. Input port 1560 protrudes from or is accessible within body case 1510.

Unlike prior embodiments, L-Device 1500 comprises a connector (not shown) located at a bottom sidewall 1512 of body case 1510. According to one embodiment, the connector may be an edge connector (male or female), but other type of connectors may be used. An adapter cover 1565 is placed over the connector when no receiver modules are coupled to the connector.

Each T-Device 1570₁-1570_{M} is provided with a corresponding receiver module 1575₁-1575_{M}, which is adapted for coupling in series with each other and to the connector of L-Device 1500. Each receiver module 1575₁-1575_{M} may be programmed to transmit and receive signals over one of a plurality of communications channels. It is contemplated that each communication channel may correspond to a different prescribed frequency.

According to one embodiment of the invention, receiver modules 1575₁-1575_{M} are programmed automatically, based on their placement in relation to the connector of L-Device 1500. For instance, receiver module 1570₁ may be set to a first frequency while receiver module 1570_{N} may be set to an Nth frequency, which does not interfere with the first frequency. T-Device 1570₁-1570_{M}, however, may be programmed by the user selecting a communications channel based on placement at the T-Device 1500.

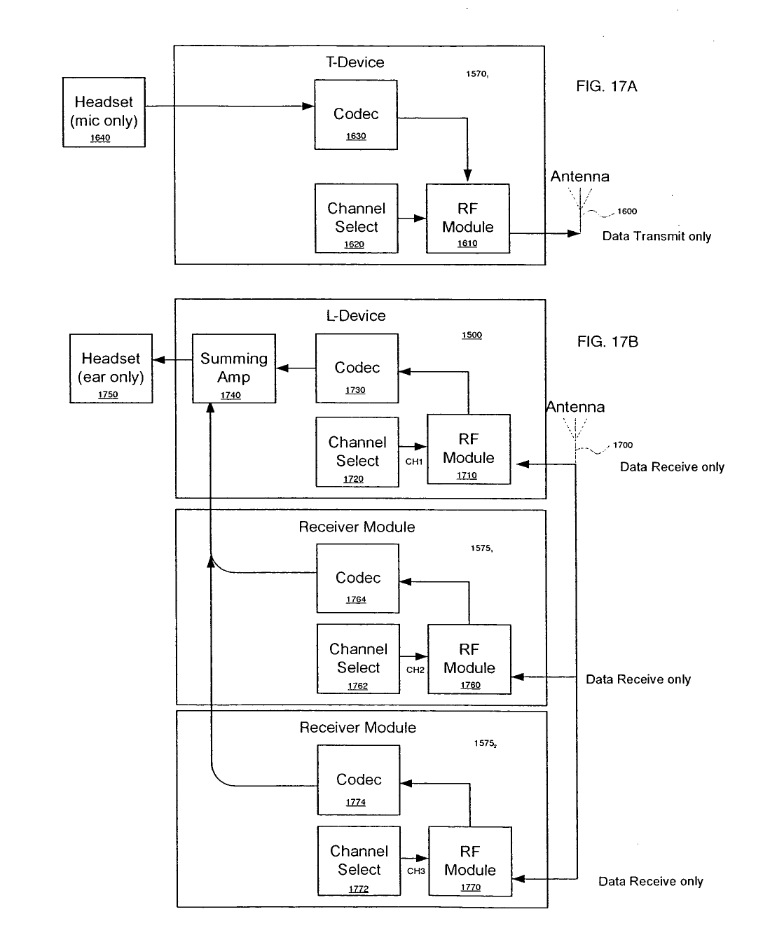

Referring now to FIG. 17A, an exemplary embodiment of internal circuitry within T-Device 1570₁ of FIGS. 16 is shown. T-Device 1570₁ comprises an antenna 1600, a RF module 1610, a channel select logic 1620, a codec 1630 and a microphone 1640. Herein, microphone 1640 receives an analog signal and routes the analog signal to a codec 1630. Codec 1630 amplifies, filters and digitizes the signal for transmission to RF module 1610. RF module 1610 modulates the signal based on the channel value set for channel select logic 1620 by the user. For instance, the channel value may be set by turning of a knob, depression of one or more control buttons, etc.

Referring now to FIG. 17B, an exemplary embodiment of internal circuitry within L-Device 1500 of FIGS. 16 is shown. L-Device 1500 comprises an antenna 1700, a RF module 1710, channel select logic 1720, a codec 1730, a summing amplifier 1740 and a headset 1750. Herein, antenna 1700 receives a wireless message and performs amplification, filtration and demodulation operations on information associated with the wireless message. Channel select logic 1720 controls demodulation of the received wireless message based on the channel value provided by channel select logic 1720. Herein, channel select logic 1720 is assigned a first channel value (CH1). Codec 1730 performs digital-to-analog conversion, which is amplified by summing amplifier 1740 to produce an audible sound at headset 1750.

In addition, a receiver module 1575₁ comprises a RF module 1760, channel select logic 1762 and a codec 1764, which collectively operate as described above. In particular, receiver module 1575₁ is adapted for coupling codec 1764 to summing amplifier 1740 and RF module 1760 to antenna 1700. The same architecture is provided for coupling additional receiver modules, such as RF module 1770, channel select logic 1772 and codec 1774 of receiver module 1575₂.

Based on the positioning of the receiver modules 1575₁ and 1575₂, channel select values are assigned a second channel value (CH2, where CH2 is not equal to CH1) and a third channel value (CH3, where CH3 is not equal to CH2 or CH1).

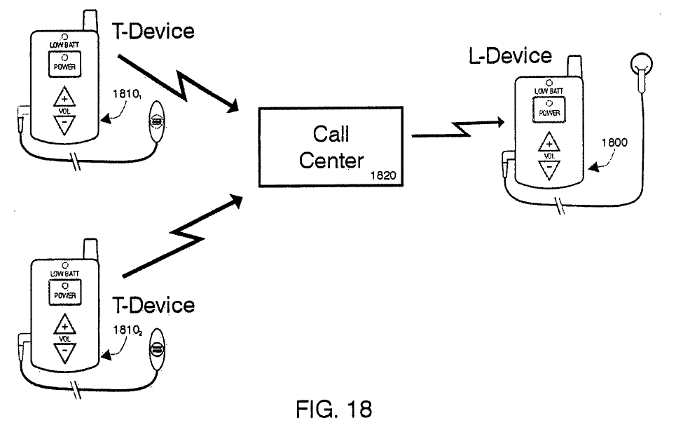

Referring now to FIG. 18, a fifth exemplary embodiment of a hearing-impaired communication system 100 deployed as a designated call center is shown. Herein, L-Device 1800 and T-Devices 1810, and 18102 can communicate through radio frequency signals over the cellular band by calling into a designated call center 1820. Call center 1820 is established by a wireless carrier, which allocates call time at no cost to the user or at a substantially reduced rate.

According to one embodiment, L-Device 1800 may be adapted as a receive-only cell phone with oversized controls, frequency control, ambient microphone, etc. made specifically for the hearing impaired. Ideally, calls made to a special toll-free conference number could only be heard by a registered L-Device, thus limiting abuse to the system. The owner of L-Device 1800 would be charged, if at all, by the total talked minutes.

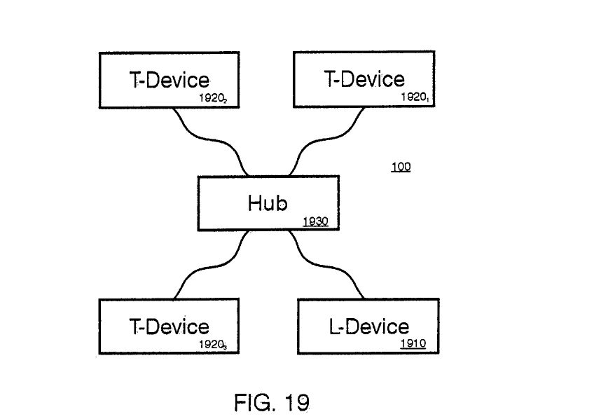

Referring to FIG. 19, a sixth exemplary embodiment of a hearing impaired communication system 100 is shown. Herein, L-Device 1910 and T-Devices 1920₁, 1920₂ and 1920₃ are hard-wired together over a common hub 1930. Hub 1930 controls peer-to-peer routing of audio signals from each of T-Devices 1920₁, 1920₂ and 1920₃ to L-Device 1910. It is contemplated, however, that hub 1930 may be implemented as a single table-top box into which microphones and earpieces are connected. The table-top box would be configured to control multicast routing of the audio signals.

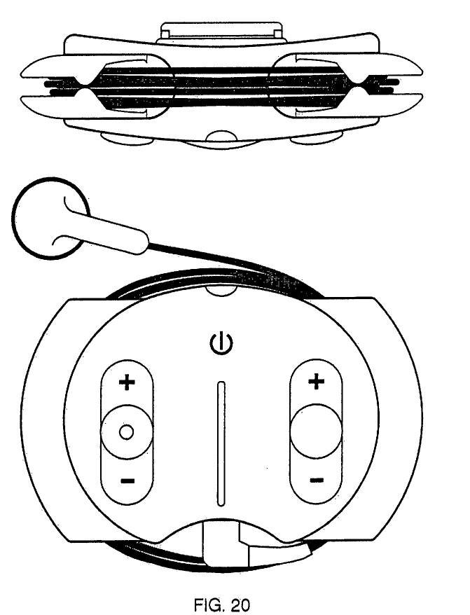

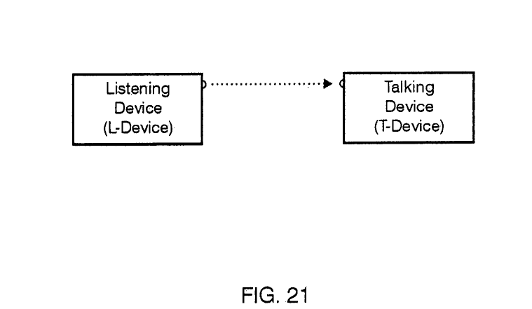

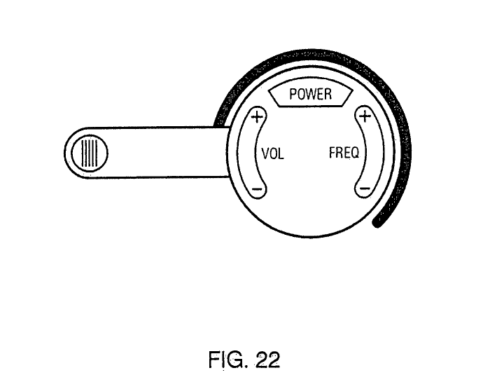

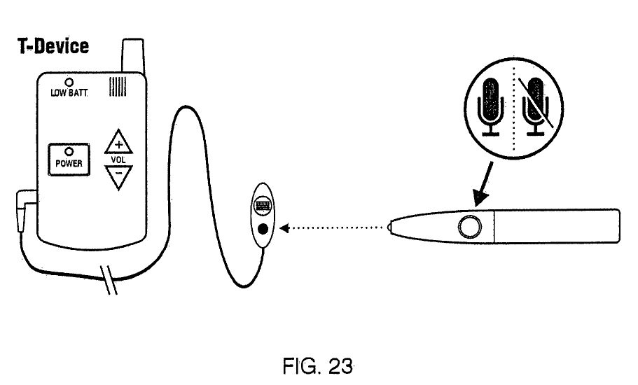

Other features of a L-Device or a T-Device include, but are not limited or restricted to the following: (1) a built-in manual or automatic interconnect rewinder as shown in FIG. 20; (2) Infrared communications between L-Device and one or more T-Devices as shown in FIG. 21; (3) fabrication of an all-in-one earpiece adapted with L-Device or T-Device functionality as shown in FIG. 22; and (4) laser pointer activation of an IR detector of the T-Device. Upon detection of a laser beam or unidirectional beam of light (e.g., IR beam), the IR detector activates or deactivates the microphone associated with the T-Device. This enables the user to focus on a particular talker as shown in FIG. 23. For instance, detection of an IR beam by an IR detector of a first T-Device causes the first T-Device to be activated. However, in order to hear a second individual using the second T-Device, the second T-Device would be activated as well. Alternatively, if the user wants to exclusively hear the user of the second T-Device (not the user of the first T-Device), the user may deactivate the microphone of the first T-Device by again directing an IR beam to the IR detector of the first T-Device.

In the foregoing description, the invention is described with reference to specific exemplary embodiments thereof. It will, however, be evident that various modifications and changes may be made thereto without departing from the broader spirit and scope of the present invention. The specification and drawings are accordingly to be regarded in an illustrative rather than in a restrictive sense.

1. An apparatus comprising:
an antenna to receive audio signals over a wireless interconnect;
circuitry to process the audio signals;
a body case housing the circuitry, the body case including at least a first input/output (I/O) control to adjust a level of volume for playback of the audio signals, at least a second I/O control to concentrate the audio signal on a selected audible frequency range capable of being heard by the user, and an input jack; and
an earpiece including an interconnect adapted for coupling to the input jack.

2. The apparatus of claim 1 further comprising a microphone.

3. The apparatus of claim 2 further comprising a switch to route the audio signal received over the antenna to the earpiece when the switch placed in a first position and to route audio received from the microphone when the switch is placed in a second position.

4. The apparatus of claim 3, wherein the switch is positioned on the interconnect coupling the earpiece to the input jack.

5. The apparatus of claim 1, wherein the circuitry comprises
a radio frequency module to recover the audio signals from a message, and thereafter, to filter and demodulate the audio signals in a digital format;
a baseband controller to process the audio signals in the digital format; and
a decoder to produce analog audio representative of the audio signals in the digital format.

6. The apparatus of claim 1, wherein the audio signals are received from multiple sources concurrently communicating with the apparatus.

7. An apparatus comprising:
an antenna to transmit audio signals in a digital format over a wireless interconnect;
a body case including an input jack and a bias control configured to bias the audio signals transmitted over the antenna to enable determination of a directional position of a user of the apparatus to a listener receiving the audio signals; and
a microphone to receive the audio signals in an analog format, the microphone including an interconnect adapted for coupling to the input jack.

8. The apparatus of claim 7, wherein the bias control is a multi-position switch, each position representing a specific directional position of the user to the listener.

9. The apparatus of claim 7, wherein the bias control is a slidable adjustment bar and a position of the adjustment bar representing a specific directional position of the user to the listener.

10. The apparatus of claim 7, wherein the body case further comprises at least a first input/output (I/O) control to adjust a level of volume for playback of received audio signals, at least a second I/O control to concentrate the received audio signal on a selected audible frequency range capable of being heard by the user.

11. The apparatus of claim 7 further comprising a microphone.

12. The apparatus of claim 11 further comprising a switch to route the audio signal received over the antenna to the earpiece when the switch placed in a first position and to route audio received from the microphone when the switch is placed in a second position.

13. The apparatus of claim 12, wherein the switch is positioned on the interconnect coupling the earpiece to the input jack.

14. An apparatus comprising:
a body case including an antenna and a connector;
a first receiver module adapted for coupling to the connector and the antenna, the first receiver module to process a signal including audio received over a first communication channel; and
a second receiver module adapted for coupling to a connector of the first receiver module and the antenna, the second receiver module to process a signal including audio received over a second communication channel.

15. The apparatus of claim 14, wherein the body case includes the connector positioned along a sidewall of the body case, the body case including circuitry to process a signal including audio received over a third communication channel differing from the first communication channel and the second communication channel.

16. The apparatus of claim 15, wherein the circuitry of the body case includes a first radio frequency module to modulate the signal including audio received over the third communication channel, a first channel select logic to control modulation by the radio frequency module, a first decoder coupled to the radio frequency module to perform digital-to-analog conversion of the signal including audio received over the third communication channel and a summing amplifier coupled to the first decoder.

17. The apparatus of claim 16, wherein the first receiver module comprises a second radio frequency module to modulate the signal including audio received over the first communication channel, a second channel select logic to control modulation by the second radio frequency module, and a second decoder, to perform digital-to-analog conversion of the signal including audio received over the first communication channel, the second decoder is coupled to the second radio frequency module and the summing amplifier.

18. The apparatus of claim 17, wherein the second receiver module comprises a third radio frequency module to modulate the signal including audio received over the second communication channel, a third channel select logic to control modulation by the third radio frequency module, and a third decoder, to perform digital-to-analog conversion of the signal including audio received over the second communication channel, the third decoder is coupled to the third radio frequency module and the summing amplifier.

19. The apparatus of claim 14, wherein the first channel select logic is manually adjusted by a user of the apparatus.

20. The apparatus of claim 14, wherein the first and second receiver modules are assigned to corresponding the first and second communication channels based on a position of the receiver modules with respect to the body case.

21. A method comprising:
concurrently receiving spread-spectrum wireless signals from a plurality of sources by a listening device for a hearing-impaired user, the spread-spectrum wireless signals comprise audio in a digital format;
filtering the audio in the digital format to retain the audio within a specified audible frequency range set by the hearing-impaired user;
converting the filtered audio into an analog format; and
outputting the filtered, analog audio to be perceived by the hearing-impaired user.

22. An apparatus comprising:
a microphone to receive the audio signals in an analog format;
a body case in communications with the microphone, the body case including circuitry to receive the audio signals in the analog format and to convert the audio signals in the analog format into audio signals in a digital format;
an antenna to transmit audio signals in the digital format over a wireless interconnect; and
an infrared detector circuitry that, when activated, enables communications between the microphone and the body case and disables communications between the microphone and the body case when deactivated.
